(19) United States
(12) Patent Application Publication
(10) Pub. No.: US 2019/0351538 A1
(43) Pub. Date: Nov. 21, 2019

(54) PERCUSSION APPARATUS

(71) Applicant: MONTABERT, SAINT-PRIEST (FR)

(72) Inventor: Bernard PIRAS, VERNAISON (FR)

(21) Appl. No.: 16/461,694

(22) PCT Filed: Oct. 19, 2017
(86) PCT No.: PCT/FR2017/052877

§ 371 Date: May 16, 2019

(30) Foreign Application Priority Data
Nov. 17, 2016 (FR) 16/61136

(51) Int. Cl. B25D 9/12; B25D 17/08

(52) U.S. Cl. CPC B25D 9/12; B25D 17/08

(57) ABSTRACT

This percussion apparatus includes a body; a tool including a mounting portion slidably mounted in the body; and a striking piston mounted so as to be alternately displaced within the body and configured to strike the mounting portion. The mounting portion of the tool includes an annular retaining rib including a first bearing surface configured to cooperate with a first stop surface provided on the body so as to limit the displacement stroke of the tool towards the striking piston, and a second bearing surface opposite to the first bearing surface and configured to cooperate with a second stop surface provided on the body so as to limit the displacement stroke of the tool opposite to the striking piston and to retain the mounting portion of the tool in the body.

### CROSS REFERENCE TO RELATED APPLICATIONS

This application is a National Stage of PCT Application No. PCT/FR2017/052877 filed on Oct. 19, 2017, which claims priority to French Patent Application No. 16/61136 filed on Nov. 17, 2016, the contents each of which are incorporated herein by reference thereto.

### TECHNICAL FIELD

The present invention concerns a percussion apparatus, and more particularly a percussion apparatus actuated by a pressurized fluid.

### BACKGROUND

The percussion apparatuses actuated by a pressurized fluid, also called rock breakers, are very powerful apparatuses intended to break rocks. Such percussion apparatuses can be used for many applications, and in particular to create foundations, reduce blocks after a blasting operation, dig tunnels or roadways, etc.

More particularly, a percussion apparatus is intended to be installed at the tip of the arm of a hydraulic excavator which will serve as a carrier machinery and which will provide the hydraulic energy necessary for the operation of the percussion apparatus and the thrust essential to maintain the recoil effort created by the operation of the percussion apparatus.

A percussion apparatus creates shock waves generated by the impact of a striking piston hitting a tool in contact with the rock to be broken. This tool constitutes the wear part intended to transmit the shock waves which will fracture the rock. This tool should also resist the rotational torque created by the terrain when a chisel type tool is used and said tool is engaged in a fault of the rock. Finally, for practical reasons, this tool should be mechanically held inside the percussion apparatus during the displacements of the latter or during idle strikes due to a lack of bearing.

EP0575270 discloses a device for holding the tool in the body of the percussion apparatus. In particular, such a holding device comprises two holding keys each configured to cooperate with a stop face defined by a respective transverse notch provided on the tool. Such a holding device ensures an effective and reliable holding of the tool for most possible applications of a percussion apparatus.

However, for very difficult applications, such as digging tunnels where the environment is very aggressive, the contact surfaces between the tool and the holding keys remain too limited to avoid rapid wear of the tool and of the holding keys or seizures likely to create cracks of the body or the tool.

### BRIEF SUMMARY

The present invention aims at overcoming all or part of these drawbacks.

The technical problem underlying the invention consists in particular in providing a percussion apparatus which has a simple structure, while ensuring an effective and reliable operation of the percussion apparatus including for difficult applications.

To this end, the present invention concerns a percussion apparatus, including at least:
a body comprising a first body portion and a second body portion,
a tool including a mounting portion slidably mounted in the second body portion, the mounting portion being provided with a striking surface,
a striking piston mounted so as to be alternately displaced within the first body portion, and configured to strike the striking surface of the mounting portion,

the mounting portion of the tool including an annular retaining rib including a first bearing surface configured to cooperate with a first stop surface provided in the second body portion so as to limit the displacement stroke of the tool towards the striking piston, and a second bearing surface opposite to the first bearing surface and configured to cooperate with a second stop surface provided in the second body portion so as to limit the displacement stroke of the tool opposite to the striking piston and to retain the mounting portion of the tool in the second body portion,

characterized in that the percussion apparatus further includes:
a first guide element and a second guide element mounted in the second body portion, and configured to slidably guide the mounting portion of the tool, the first and second guide elements being disposed on either side of the annular retaining rib, and
a stop ring mounted in the second body portion and disposed between the first and second guide elements, the first stop surface being provided on the stop ring and the second stop surface is provided on the second guide element.

Such a configuration of the tool, and in particular the presence of the annular retaining rib, ensures large contact surfaces between the tool and the body of the apparatus, in contrast with the apparatuses of the prior art where these contact surfaces were limited to the radii of curvature of the holding keys and the radii of curvature of the stop faces defined by the transverse notches provided on the tool.

Consequently, the percussion apparatus according to the present invention considerably limits the wear of the tool and of the body of the apparatus, and the risks of seizure of the percussion apparatus, and thus has a high reliability.

The percussion apparatus may further have one or more of the following features, considered alone or in combination.

According to an embodiment of the invention, at least one, and for example each, of the first and second bearing surfaces is annular. These arrangements enlarge the contact surfaces between the tool and the body of the percussion apparatus even further, and therefore the reliability of the percussion apparatus.

According to an embodiment of the invention, at least one, and for example each, of the first and second stop surfaces is annular.

According to an embodiment of the invention, the striking piston and the tool extend substantially coaxially.

According to an embodiment of the invention, the first body portion and the second body portion respectively include a piston bore and a tool bore.

According to an embodiment of the invention, the first bearing surface converges towards the striking piston, and the second bearing surface converges opposite to the striking piston.

According to an embodiment of the invention, each of the first and second guide elements is formed by a guide bushing.

According to an embodiment of the invention, the first and second guide elements are mounted in the tool bore. Thus, the first and second guide elements are more particularly configured to slidably guide the mounting portion of the tool within the tool bore.

According to an embodiment of the invention, the second guide element is removably mounted in the second body portion, and more particularly in the tool bore.

According to an embodiment of the invention, the mounting portion of the tool includes a first guided portion and a second guided portion disposed on either side of the annular retaining rib and configured to cooperate respectively with the first and second guide elements.

According to an embodiment of the invention, each of the first and second guide elements includes a central bore through which the mounting portion of the tool, and for example one of the first and second guided portions of the mounting portion, extends.

According to an embodiment of the invention, the percussion apparatus further includes at least one holding element configured to hold the second guide element in the second body portion.

According to an embodiment of the invention, the at least one holding element includes at least one holding key. For example, the at least one holding key extends for example through a through bore provided on the second body portion and a holding notch provided on the second guide element.

According to an embodiment of the invention, the percussion apparatus includes two holding keys extending through two holding notches provided on the second guide element and diametrically opposite to each other.

According to an embodiment of the invention, the at least one holding element is removably fastened, for example by screwing, to an end face of the second body portion, and includes a passage bore intended for the passage of the tool.

According to an embodiment of the invention, the mounting portion of the tool and at least one of the first and second guide elements are configured to rotatably immobilize the mounting portion relative to the second body portion.

According to an embodiment of the invention, the central bore of at least one of the first and second guide elements has a non-circular cross-section.

According to an embodiment of the invention, the mounting portion of the tool includes at least one flattened surface configured to cooperate with one of the first and second guide elements.

According to an embodiment of the invention, the stop ring is distinct from the first and second guide elements. Advantageously, the stop ring is axially shifted with respect to the first and second guide elements.

According to an embodiment of the invention, the percussion apparatus further comprises a striking chamber configured to be pressurized and at least partially delimited by the striking piston and the mounting portion of the tool, and a sealing element configured to seal the striking chamber. These arrangements allow constantly generating a thrust force on the mounting portion of the tool, and in particular on the striking surface of the tool, and therefore urging the tool away from its theoretical impact position. Therefore, if the operator does not exert, using the carrier machinery, a minimum thrust on the tool to counteract the thrust force exerted on the latter, the striking piston cannot strike the tool. Thus, the percussion apparatus according to the present invention allows limiting idle strikes on the tool.

According to an embodiment of the invention, the striking chamber and the sealing element are configured so as to urge the tool away from its theoretical striking position, and more particularly to generate a thrust force on the mounting portion of the tool so as to urge the tool away from its theoretical impact position.

According to an embodiment of the invention, the striking chamber is at least partially delimited by the striking surface of the mounting portion.

According to an embodiment of the invention, the sealing element is disposed between the second body portion and the mounting portion of the tool.

According to an embodiment of the invention, the sealing element is fastened on the second body portion and is configured to cooperate with the mounting portion of the tool, and for example with a portion of the mounting portion disposed between the first guided portion and the annular retaining rib.

According to an embodiment of the invention, the sealing element is an O-ring gasket or a lip seal.

According to an embodiment of the invention, the sealing element is fastened in an annular groove provided on the second body portion.

According to an embodiment of the invention, the sealing element is disposed between the first guide element and the annular retaining rib.

According to an embodiment of the invention, the sealing element is disposed between the first guide element and the stop ring.

### BRIEF DESCRIPTION OF THE DRAWINGS

Anyway, the invention will be better understood using the following description with reference to the appended schematic drawings representing, as non-limiting examples, several embodiments of this percussion apparatus.

FIG. 1 is a schematic longitudinal sectional view of a percussion apparatus according to a first embodiment of the invention.

FIG. 2 is a partial longitudinal sectional view of the percussion apparatus of FIG. 1.

FIG. 3 is a side view of a tool of the percussion apparatus of FIG. 1.

FIG. 4 is a sectional view along the line IV-IV of FIG. 3.

FIG. 5 is a partial longitudinal sectional view of a percussion apparatus according to a second embodiment of the invention.

FIG. 6 is a partial longitudinal sectional view of the percussion apparatus according to a third embodiment of the invention.

FIG. 7 is a partial longitudinal sectional view of the percussion apparatus according to a fourth embodiment of the invention.

### DETAILED DESCRIPTION

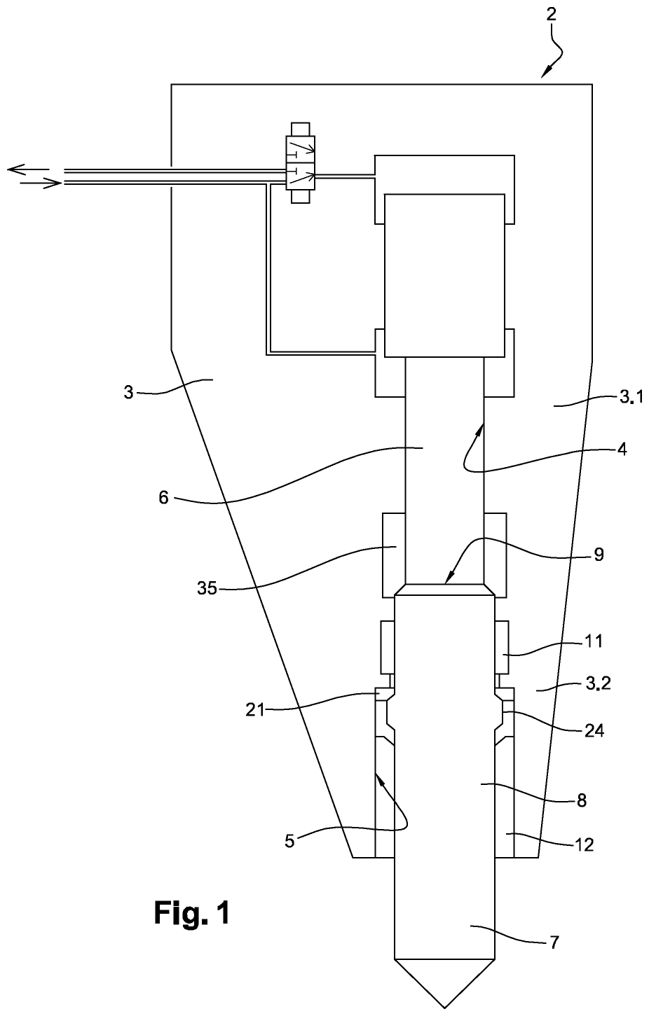

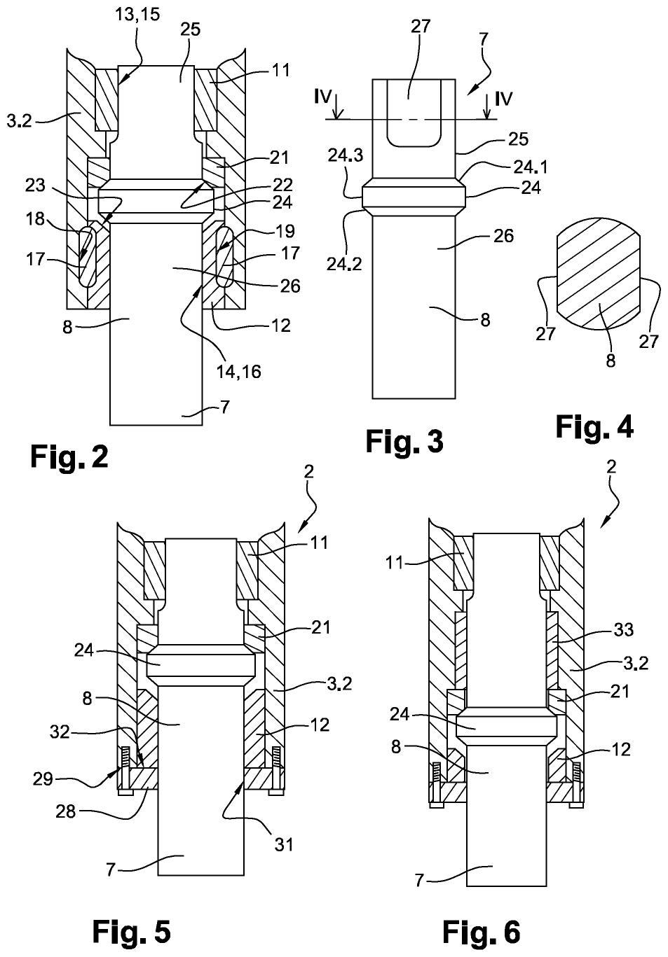

The percussion apparatus 2, represented in FIGS. 1 to 3 and also called hydraulic rock breaker, comprises a body 3 including a first body portion 3.1 and a second body portion 3.2 which comprise respectively a piston bore 4 and a tool bore 5. Advantageously, the piston bore 4 and the tool bore 5 extend coaxially.

The percussion apparatus 2 also includes a stepped striking piston 6 mounted so as alternately slide within the piston bore 4, and a tool 7 including a mounting portion 8 slidably mounted in the tool bore 5 and provided with a striking surface 9. During each operating cycle of the percussion apparatus 2, the striking piston 6 is intended to strike against the striking surface 9 of the tool 7. It should be noted that the piston bore 4 and the tool bore 5 may be directly formed in the body 3 or be formed in parts attached to the body 3.

In addition, the percussion apparatus 2 includes a first guide element 11 and a second guide element 12 mounted in the second body portion 3.2, and configured to slidably guide the mounting portion 8 of the tool 7 in the tool bore 5. According to the embodiment represented in FIGS. 1 to 3, the first and second guide elements 11, 12 are formed by two guide bushings, and are mounted coaxially in the tool bore 5. Advantageously, the first and second guide elements 11, 12 include respectively two central bores 13, 14 through which the mounting portion 8 of the tool 7 extends, and two guide surfaces 15, 16 which are configured to cooperate with the mounting portion 8 of the tool 7.

Advantageously, the second guide element 12 is removably mounted in the tool bore 5. To this end, according to the embodiment represented in FIGS. 1 to 3, the percussion apparatus 2 includes two holding elements 17, such as holding keys, configured to hold the second guide element 12 in the tool bore 5. Each holding element 17 extends for example through a respective through bore 18 provided on the second body portion 3.2 and a respective holding notch 19 provided on the second guide element 12. Each holding element 17 may for example have a circular or oblong cross-section.

The percussion apparatus 2 also includes a stop ring 21 mounted in the second body portion 3.2 and extending coaxially with the first and second guide elements 11, 12. More particularly, the stop ring 21 is disposed between the first and second guide elements 11, 12, and is provided with of a first stop surface 22 which is advantageously annular.

The percussion apparatus 2 further includes a second stop surface 23 which is advantageously annular and which is provided, according to the embodiment represented in FIGS. 1 to 3, directly on the second guide element 12.

As shown more particularly in FIG. 3, the mounting portion 8 of the tool 7 more particularly includes an annular retaining rib 24, and first and second guided portions 25, 26 disposed on either side of the annular retaining rib 24 and configured to cooperate respectively with the first and second guide elements 11, 12.

The annular retaining rib 24 advantageously includes a first bearing surface 24.1 configured to cooperate with the first stop surface 22 provided on the stop ring 21 so as to limit the displacement stroke of the tool 7 towards the striking piston 6, and a second bearing surface 24.2 opposite to the first bearing surface 24.1 and configured to cooperate with the second stop surface 23 provided on the second guide element 12 so as to limit the displacement stroke of the tool 7 opposite to the striking piston 6 and to retain the mounting portion 8 of the tool 7 in the second body portion 3.2.

Advantageously, each of the first and second bearing surfaces 24.1, 24.2 is annular, and each of the first and second stop surfaces 22, 23 is annular.

According to the embodiment represented in FIGS. 1 to 3, the first bearing surface 24.1 converges towards the striking piston 6, the second bearing surface 24.2 converges opposite to the striking piston 6, and the annular retaining rib 24 further includes a cylindrical intermediate surface 24.3 connecting the first and second bearing surfaces 24.1, 24.2.

Advantageously, the mounting portion 8 of the tool 7 and at least one of the first and second guide elements 11, 12 are configured to rotatably immobilize the mounting portion 8 relative to the second body portion 3.2. According to the embodiment represented in FIGS. 1 to 3, the first guided portion 25 includes two diametrically opposite flattened surfaces 27, and the central bore 13 of the first guide element 11 has a cross-section substantially complementary with the cross-section of the first guided portion 25.

FIG. 5 represents a percussion apparatus 2 according to a second embodiment which differs from that represented in FIGS. 1 to 3 essentially in that it includes a holding element 28 removably fastened, for example by screwing, to an end face 29 of the second body portion 3.2, so as to retain the second guide elements 12 in the tool bore 5. The holding element 28 advantageously includes a passage bore 31 intended for the passage of the tool 7. According to such an embodiment of the invention, the holding element 28 includes a stop surface 32 against which the second guide element 12 is adapted to bear.

FIG. 6 represents a percussion apparatus 2 according to a third embodiment which differs from that represented in FIG. 5 essentially in that it includes an intermediate guide element 33 disposed between the stop ring 21 and the first guide element 11.

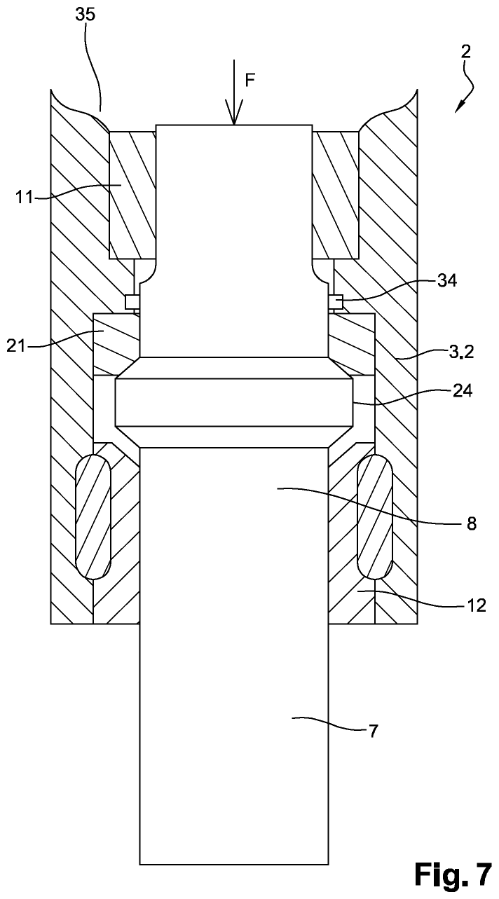

FIG. 7 represents a percussion apparatus 2 according to a third embodiment which differs from that represented in FIGS. 1 to 3 essentially in that it includes a sealing element 34, such as an O-ring gasket or a lip seal, configured to seal a striking chamber 35 at least partially delimited by the striking piston 6 and the first guided portion 25 of the tool 7, the striking chamber 35 being configured to be pressurized. For example, the sealing element 34 is fastened in an annular groove provided on the second body portion 3.2 between the first guide element 11 and the stop ring 21, and is configured to cooperate with the mounting portion 8 of the tool 7, and for example with a portion of the mounting portion 8 disposed between the first guided portion 25 and the annular retaining rib 24. The presence of such a sealing element 34 allows generating a thrust force F, oriented axially opposite to the striking piston 6, on the mounting portion 8 of the tool 7, and in particular on the striking surface 9 of the tool 8, and therefore urging the tool 8 away from its theoretical impact position. Therefore, if the operator does not exert, using the carrier machinery on which the percussion apparatus 2 is fastened, a minimum thrust on the tool 8 to counteract the thrust force F exerted on the latter, the striking piston 6 cannot strike the tool 8. Thus, the percussion apparatus 2 according to the present invention allows limiting idle strikes on the tool 8.

According to a variant which is not represented in the Figures, the first stop surface 22 may be provided directly on the second body portion 3.2 or be provided on the first guide element 11, and the second stop surface 23 may be provided on a stop member distinct from the second guide element 12 and also mounted in the tool bore 5.

It goes without saying that the invention is not only limited to the sole embodiments of this percussion apparatus, described hereinabove as examples, but it encompasses on the contrary all variants thereof.

1. A percussion apparatus, including at least:
a body comprising a first body portion and a second body portion,
a tool including a mounting portion slidably mounted in the second body portion, the mounting portion being provided with a striking surface, and
a striking piston mounted so as to be alternately displaced within the first body portion, and configured to strike the striking surface of the mounting portion,
the mounting portion of the tool including an annular retaining rib including a first bearing surface configured to cooperate with a first stop surface provided in the second body portion so as to limit the displacement stroke of the tool towards the striking piston, and a second bearing surface opposite to the first bearing surface and configured to cooperate with a second stop surface provided in the second body portion so as to limit the displacement stroke of the tool opposite to the striking piston and to retain the mounting portion of the tool in the second body portion,
characterized in that the percussion apparatus further includes:
a first guide element and a second guide element mounted in the second body portion, and configured to slidably guide the mounting portion of the tool, the first and second guide elements being disposed on either side of the annular retaining rib, and
a stop ring mounted in the second body portion and disposed between the first and second guide elements, the first stop surface being provided on the stop ring and the second stop surface is provided on the second guide element.

2. The percussion apparatus according to claim 1, wherein at least one of the first and second bearing surfaces is annular.

3. The percussion apparatus according to claim 1, wherein at least one of the first and second stop surfaces is annular.

4. The percussion apparatus according to claim 1, which further includes at least one holding element configured to hold the second guide element in the second body portion.

5. The percussion apparatus according to claim 1, wherein the mounting portion of the tool and at least one of the first and second guide elements are configured to rotatably immobilize the mounting portion relative to the second body portion.

6. The percussion apparatus according to claim 1, which further comprises a striking chamber at least partially delimited by the striking piston and the mounting portion of the tool and configured to be pressurized, and a sealing element configured to seal the striking chamber.

7. The percussion apparatus according to claim 6, wherein the sealing element is disposed between the second body portion and the mounting portion of the tool.

8. The percussion apparatus according to claim 6, wherein the sealing element is fastened on the second body portion and is configured to cooperate with the mounting portion of the tool.

9. The percussion apparatus according to claim 6, wherein the sealing element is disposed between the first guide element and the annular retaining rib.

10. The percussion apparatus according to claim 6, wherein the striking chamber and the sealing element are configured so as to urge the tool away from its theoretical striking position.

11. The percussion apparatus according to claim 1, wherein the second guide element is removably mounted in the second body portion.

12. The percussion apparatus according to claim 2, wherein at least one of the first and second stop surfaces is annular.

13. The percussion apparatus according to claim 12, which further includes at least one holding element configured to hold the second guide element in the second body portion.

14. The percussion apparatus according to claim 13, wherein the mounting portion of the tool and at least one of the first and second guide elements are configured to rotatably immobilize the mounting portion relative to the second body portion.

15. The percussion apparatus according to claim 14, which further comprises a striking chamber at least partially delimited by the striking piston and the mounting portion of the tool and configured to be pressurized, and a sealing element configured to seal the striking chamber.

16. The percussion apparatus according to claim 15, wherein the sealing element is disposed between the second body portion and the mounting portion of the tool.

17. The percussion apparatus according to claim 16, wherein the sealing element is fastened on the second body portion and is configured to cooperate with the mounting portion of the tool.

18. The percussion apparatus according to claim 17, wherein the sealing element is disposed between the first guide element and the annular retaining rib.

19. The percussion apparatus according to claim 18, wherein the striking chamber and the sealing element are configured so as to urge the tool away from its theoretical striking position.

20. The percussion apparatus according to claim 19, wherein the second guide element is removably mounted in the second body portion.
